(19) United States
(12) Patent Application Publication
(10) Pub. No.: US 2017/0126658 A1
(43) Pub. Date: May 4, 2017

(54) Establishing and Maintaining an Authenticated Connection Between a Smart Pen and a Computing Device

(71) Applicant: Livescribe Inc., Oakland, CA (US)

(72) Inventors: David Robert Black, Sunnyvale, CA (US); Brett Reed Halle, Pleasanton, CA (US)

(21) Appl. No.: 15/406,420

(22) Filed: Jan. 13, 2017

Related U.S. Application Data
(63) Continuation of application No. 14/989,391, filed on Jan. 6, 2016, now abandoned.
Application No. 14/989,391 is a continuation of application No. 14/062,552, filed on Oct. 24, 2013, now abandoned.
(60) Provisional application No. 61/719,286, filed on Oct. 26, 2012.

(51) Int. Cl. H04L 29/06; G06F 3/038; G06F 3/0354; G06F 21/44; H04W 12/06

(52) U.S. Cl. CPC H04L 63/083; H04L 63/105; G06F 21/44; H04W 12/06; G06F 3/03545; G06F 3/0383; G06F 2203/0384

(57) ABSTRACT

A system and method establishes a connection between a smart pen and a computing device, and establishes a privilege level that regulates data requests for specific data from the smart pen. The smart pen determines whether a connection should be established between the smart pen and a computing device, based on device information received from the computing device. If a connection is established, a privilege level is established for an application executing on the computing device based on the device information, which determines whether a request from the application for specific data from the smart pen is allowed or denied.

### CROSS-REFERENCE TO RELATED APPLICATIONS

This application is a continuation of U.S. patent application Ser. No. 14/989,391 filed on Jan. 6, 2016 which is a continuation of U.S. patent application Ser. No. 14/062,552 filed on Oct. 24, 2013, which claims the benefit of U.S. Provisional Application No. 61/719,286, filed Oct. 26, 2012, the disclosures of which are incorporated herein by reference.

### BACKGROUND

This invention relates generally to pen-based computing systems, and more particularly to synchronizing recorded writing, audio, and digital content in a smart pen environment.

A smart pen is an electronic device that digitally captures writing gestures of a user and converts the captured gestures to digital information that can be utilized in a variety of applications. For example, in an optics-based smart pen, the smart pen includes an optical sensor that detects and records coordinates of the pen while writing with respect to a digitally encoded surface (e.g., a dot pattern). Additionally, some traditional smart pens include an embedded microphone that enable the smart pen to capture audio synchronously with capturing the writing gestures. The synchronized audio and gesture data can then be replayed. Smart pens can therefore provide an enriched note taking experience for users by providing both the convenience of operating in the paper domain and the functionality and flexibility associated with digital environments.

### SUMMARY

Embodiments of the invention provide a system and method for establishing a connection between a smart pen and a computing device, and establishing a privilege level that regulates data requests for specific data from the smart pen. A request is transmitted from a smart pen for device information for a computing device, and the smart pen receives a response regarding the request from the computing device. The smart pen may establish a connection with the computing device depending on whether the smart pen has determined, from the device information, whether such a connection should be established. When a connection is made, a privilege level is also established for an application executing on the computing device based on the requested device information. Based on the privilege level, the smart pen determines whether to allow or deny a request from the application for specific data from the smart pen.

The specific data may include, for example, historical data, gesture data, position data, basic device data, audio data, or account data. In some embodiments, the privilege level determines whether to allow or deny requests from the application to access data in real time from the smart pen as the data is generated, access gesture data and audio data stored by the smart pen, access account information associated with a user or the smart pen, or modify data stored by the smart pen. In one embodiment, a modifier associated with the application is also established for the privilege level, based on the device information. The modifier alters one of the access policies for the privilege level.

### BRIEF DESCRIPTION OF THE DRAWINGS

FIG. 1 is a schematic diagram of an embodiment of a smart-pen based computing environment.

FIG. 2 is a diagram of an embodiment of a smart pen device for use in a pen-based computing system.

FIG. 3 is a timeline diagram demonstrating an example of synchronized written, audio, and digital content data feeds captured by an embodiment of a smart pen device.

FIG. 4 is an interaction diagram illustrating an embodiment of a method for establishing and maintaining an authenticated connection between a smart pen device and a computing device.

FIG. 5 is a table illustrating an embodiment of possible access levels that may be assigned to applications when communicating with a smart pen device.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview of a Pen-Based Computing Environment

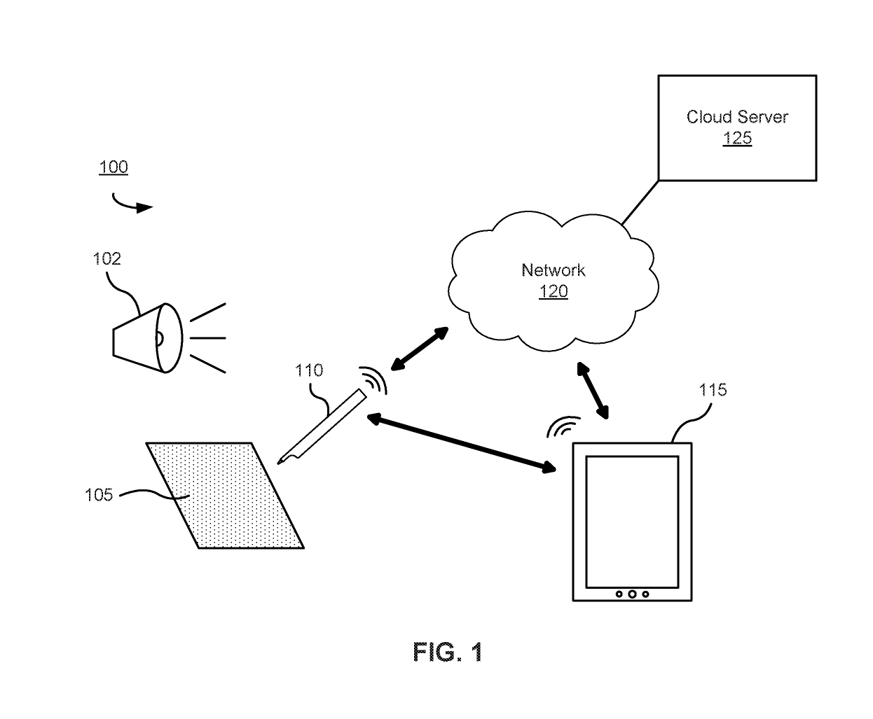

FIG. 1 illustrates an embodiment of a pen-based computing environment 100. The pen-based computing environment comprises an audio source 102, a writing surface 105, a smart pen 110, a computing device 115, a network 120, and a cloud server 125. In alternative embodiments, different or additional devices may be present such as, for example, additional smart pens 110, writing surfaces 105, and computing devices 115 (or one or more device may be absent).

The smart pen 110 is an electronic device that digitally captures interactions with the writing surface 105 (e.g., writing gestures and/or control inputs) and concurrently captures audio from an audio source 102. The smart pen 110 is communicatively coupled to the computing device 115 either directly or via the network 120. The captured writing gestures, control inputs, and/or audio may be transferred from the smart pen 110 to the computing device 115 (e.g., either in real-time or at a later time) for use with one or more applications executing on the computing device 115. Furthermore, digital data and/or control inputs may be communicated from the computing device 115 to the smart pen 110 (either in real-time or an offline process) for use with an application executing on the smart pen 110. The cloud server 125 provides remote storage and/or application services that can be utilized by the smart pen 110 and/or the computing device 115. The computing environment 100 thus enables a wide variety of applications that combine user interactions in both paper and digital domains.

In one embodiment, the smart pen 110 comprises a pen (e.g., an ink-based ball point pen, a stylus device without ink, a stylus device that leaves “digital ink” on a display, a felt marker, a pencil, or other writing apparatus) with embedded computing components and various input/output functionalities. A user may write with the smart pen 110 on the writing surface 105 as the user would with a conventional pen. During the operation, the smart pen 110 digitally captures the writing gestures made on the writing surface 105 and stores electronic representations of the writing gestures. The captured writing gestures have both spatial components and a time component. For example, in one embodiment, the smart pen 110 captures position samples (e.g., coordinate information) of the smart pen 110 with respect to the writing surface 105 at various sample times and stores the captured position information together with the timing information of each sample. The captured writing gestures may furthermore include identifying information associated with the particular writing surface 105 such as, for example, identifying information of a particular page in a particular notebook so as to distinguish between data captured with different writing surfaces 105. In one embodiment, the smart pen 110 also captures other attributes of the writing gestures chosen by the user. For example, ink color may be selected by pressing a physical key on the smart pen 110, tapping a printed icon on the writing surface, selecting an icon on a computer display, etc. This ink information (color, line width, line style, etc.) may also be encoded in the captured data.

The smart pen 110 may additionally capture audio from the audio source 102 (e.g., ambient audio) concurrently with capturing the writing gestures. The smart pen 110 stores the captured audio data in synchronization with the captured writing gestures (i.e., the relative timing between the captured gestures and captured audio is preserved). Furthermore, the smart pen 110 may additionally capture digital content from the computing device 115 concurrently with capturing writing gestures and/or audio. The digital content may include, for example, user interactions with the computing device 115 or synchronization information (e.g., cue points) associated with time-based content (e.g., a video) being viewed on the computing device 115. The smart pen 110 stores the digital content synchronized in time with the captured writing gestures and/or the captured audio data (i.e., the relative timing information between the captured gestures, audio, and the digital content is preserved).

Synchronization may be assured in a variety of different ways. For example, in one embodiment a universal clock is used for synchronization between different devices. In another embodiment, local device-to-device synchronization may be performed between two or more devices. In another embodiment, external content can be combined with the initially captured data and synchronized to the content captured during a particular session.

In an alternative embodiment, the audio and/or digital content 115 may instead be captured by the computing device 115 instead of, or in addition to, being captured by the smart pen 110. Synchronization of the captured writing gestures, audio data, and/or digital data may be performed by the smart pen 110, the computing device 115, a remote server (e.g., the cloud server 125) or by a combination of devices. Furthermore, in an alternative embodiment, capturing of the writing gestures may be performed by the writing surface 105 instead of by the smart pen 110.

In one embodiment, the smart pen 110 is capable of outputting visual and/or audio information. The smart pen 110 may furthermore execute one or more software applications that control various outputs and operations of the smart pen 110 in response to different inputs.

In one embodiment, the smart pen 110 can furthermore detect text or other pre-printed content on the writing surface 105. For example, the smart pen 110 can tap on a particular word or image on the writing surface 105, and the smart pen 110 could then take some action in response to recognizing the content such as playing a sound or performing some other function. For example, the smart pen 110 could translate a word on the page by either displaying the translation on a screen or playing an audio recording of it (e.g., translating a Chinese character to an English word).

In one embodiment, the writing surface 105 comprises a sheet of paper (or any other suitable material that can be written upon) and is encoded with a pattern (e.g., a dot pattern) that can be read by the smart pen 110. The pattern is sufficiently unique to enable to smart pen 110 to determine its relative positioning (e.g., relative or absolute) with respect to the writing surface 105. In another embodiment, the writing surface 105 comprises electronic paper, or e-paper, or may comprise a display screen of an electronic device (e.g., a tablet). In these embodiments, the sensing may be performed entirely by the writing surface 105 or in conjunction with the smart pen 110. Movement of the smart pen 110 may be sensed, for example, via optical sensing of the smart pen device, via motion sensing of the smart pen device, via touch sensing of the writing surface 105, via acoustic sensing, via a fiducial marking, or other suitable means.

The network 120 enables communication between the smart pen 110, the computing device 115, and the cloud server 125. The network 120 enables the smart pen 110 to, for example, transfer captured digital content between the smart pen 110, the computing device 115, and/or the cloud server 125, communicate control signals between the smart pen 110, the computing device 115, and/or cloud server 125, and/or communicate various other data signals between the smart pen 110, the computing device 115, and/or cloud server 125 to enable various applications. The network 120 may include wireless communication protocols such as, for example, Bluetooth, Wifi, cellular networks, infrared communication, acoustic communication, or custom protocols, and/or may include wired communication protocols such as USB or Ethernet. Alternatively, or in addition, the smart pen 110 and computing device 115 may communicate directly via a wired or wireless connection without requiring the network 120.

The computing device 115 may comprise, for example, a tablet computing device, a mobile phone, a laptop or desktop computer, or other electronic device (e.g., another smart pen 110). The computing device 115 may execute one or more applications that can be used in conjunction with the smart pen 110. For example, content captured by the smart pen 110 may be transferred to the computing system 115 for storage, playback, editing, and/or further processing. Additionally, data and or control signals available on the computing device 115 may be transferred to the smart pen 110. Furthermore, applications executing concurrently on the smart pen 110 and the computing device 115 may enable a variety of different real-time interactions between the smart pen 110 and the computing device 115. For example, interactions between the smart pen 110 and the writing surface 105 may be used to provide input to an application executing on the computing device 115 (or vice versa).

In order to enable communication between the smart pen 110 and the computing device 115, the smart pen 110 and the computing device may establish a “pairing” with each other. The pairing allows the devices to recognize each other and to authorize data transfer between the two devices. Once paired, data and/or control signals may be transmitted between the smart pen 110 and the computing device 115 through wired or wireless means.

In one embodiment, both the smart pen 110 and the computing device 115 carry a TCP/IP network stack linked to their respective network adapters. The devices 110, 115 thus support communication using direct (TCP) and broadcast (UDP) sockets with applications executing on each of the smart pen 110 and the computing device 115 able to use these sockets to communicate.

Cloud server 125 comprises a remote computing system coupled to the smart pen 110 and/or the computing device 115 via the network 120. For example, in one embodiment, the cloud server 125 provides remote storage for data captured by the smart pen 110 and/or the computing device 115. Furthermore, data stored on the cloud server 125 can be accessed and used by the smart pen 110 and/or the computing device 115 in the context of various applications.

### Smart Pen System Overview

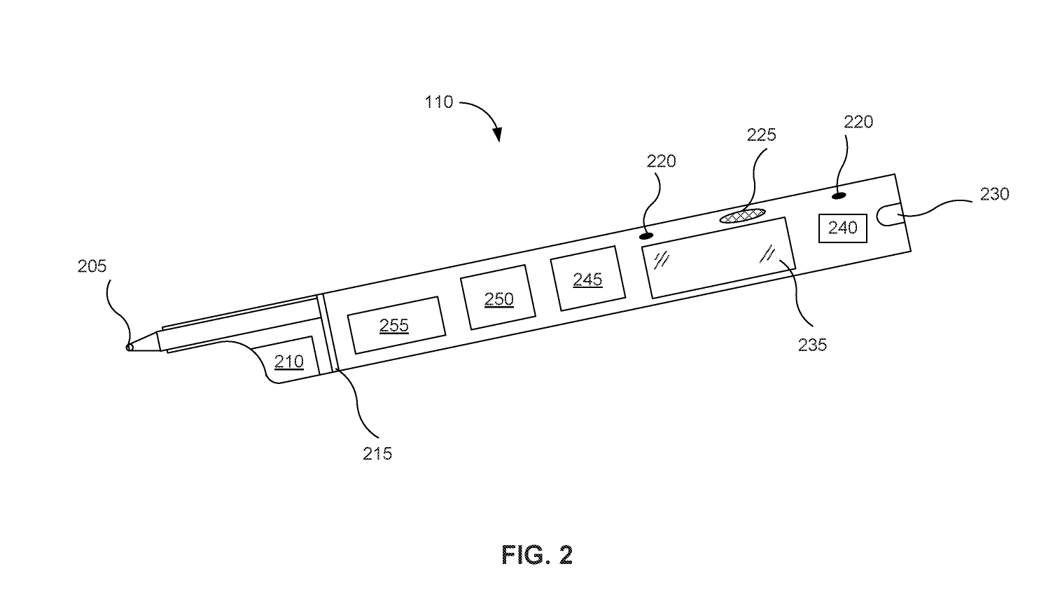

FIG. 2 illustrates an embodiment of the smart pen 110. In the illustrated embodiment, the smart pen 110 comprises a marker 205, an imaging system 210, a pen down sensor 215, one or more microphones 220, a speaker 225, an audio jack 230, a display 235, an I/O port 240, a processor 245, an onboard memory 250, and a battery 255. The smart pen 110 may also include buttons, such as a power button or an audio recording button, and/or status indicator lights. In alternative embodiments, the smart pen 110 may have fewer, additional, or different components than those illustrated in FIG. 2.

The marker 205 comprises any suitable marking mechanism, including any ink-based or graphite-based marking devices or any other devices that can be used for writing. The marker 205 is coupled to a pen down sensor 215, such as a pressure sensitive element. The pen down sensor 215 produces an output when the marker 205 is pressed against a surface, thereby detecting when the smart pen 110 is being used to write on a surface or to interact with controls or buttons (e.g., tapping) on the writing surface 105. In an alternative embodiment, a different type of “marking” sensor may be used to determine when the pen is making marks or interacting with the writing surface 110. For example, a pen up sensor may be used to determine when the smart pen 110 is not interacting with the writing surface 105. Alternative, the smart pen 110 may determine when the pattern on the writing surface 105 is in focus (based on, for example, a fast Fourier transform of a captured image), and accordingly determine when the smart pen is within range of the writing surface 105. In another alternative embodiment, the smart pen 110 can detect vibrations indicating when the pen is writing or interacting with controls on the writing surface 105.

The imaging system 210 comprises sufficient optics and sensors for imaging an area of a surface near the marker 205. The imaging system 210 may be used to capture handwriting and gestures made with the smart pen 110. For example, the imaging system 210 may include an infrared light source that illuminates a writing surface 105 in the general vicinity of the marker 205, where the writing surface 105 includes an encoded pattern. By processing the image of the encoded pattern, the smart pen 110 can determine where the marker 205 is in relation to the writing surface 105. An imaging array of the imaging system 210 then images the surface near the marker 205 and captures a portion of a coded pattern in its field of view.

In other embodiments of the smart pen 110, an appropriate alternative mechanism for capturing writing gestures may be used. For example, in one embodiment, position on the page is determined by using pre-printed marks, such as words or portions of a photo or other image. By correlating the detected marks to a digital version of the document, position of the smart pen 110 can be determined. For example, in one embodiment, the smart pen's position with respect to a printed newspaper can be determined by comparing the images captured by the imaging system 210 of the smart pen 110 with a cloud-based digital version of the newspaper. In this embodiment, the encoded pattern on the writing surface 105 is not necessarily needed because other content on the page can be used as reference points.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 105. This can be used to, for example, recognize handwriting or printed text, images, or controls on the writing surface 105. The imaging system 210 may further be used in combination with the pen down sensor 215 to determine when the marker 205 is touching the writing surface 105. For example, the smart pen 110 may sense when the user taps the marker 205 on a particular location of the writing surface 105.

The smart pen 110 furthermore comprises one or more microphones 220 for capturing audio. In an embodiment, the one or more microphones 220 are coupled to signal processing software executed by the processor 245, or by a signal processor (not shown), which removes noise created as the marker 205 moves across a writing surface and/or noise created as the smart pen 110 touches down to or lifts away from the writing surface. As explained above, the captured audio data may be stored in a manner that preserves the relative timing between the audio data and captured gestures.

The input/output (I/O) device 240 allows communication between the smart pen 110 and the network 120 and/or the computing device 115. The I/O device 240 may include a wired and/or a wireless communication interface such as, for example, a Bluetooth, Wi-Fi, infrared, or ultrasonic interface.

The speaker 225, audio jack 230, and display 235 are output devices that provide outputs to the user of the smart pen 110 for presentation of data. The audio jack 230 may be coupled to earphones so that a user may listen to the audio output without disturbing those around the user, unlike with a speaker 225. In one embodiment, the audio jack 230 can also serve as a microphone jack in the case of a binaural headset in which each earpiece includes both a speaker and microphone. The use of a binaural headset enables capture of more realistic audio because the microphones are positioned near the user's ears, thus capturing audio as the user would hear it in a room.

The display 235 may comprise any suitable display system for providing visual feedback, such as an organic light emitting diode (OLED) display, allowing the smart pen 110 to provide a visual output. In use, the smart pen 110 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 110, and the display 235 may display word phrases, static or dynamic images, or prompts as directed by such an application. In addition, the speaker 225 and audio jack 230 may also be used to play back audio data that has been recorded using the microphones 220. The smart pen 110 may also provide haptic feedback to the user. Haptic feedback could include, for example, a simple vibration notification, or more sophisticated motions of the smart pen 110 that provide the feeling of interacting with a virtual button or other printed/displayed controls. For example, tapping on a printed button could produce a “click” sound and the feeling that a button was pressed.

A processor 245, onboard memory 250 (e.g., a non-transitory computer-readable storage medium), and battery 255 (or any other suitable power source) enable computing functionalities to be performed at least in part on the smart pen 110. The processor 245 is coupled to the input and output devices and other components described above, thereby enabling applications running on the smart pen 110 to use those components. As a result, executable applications can be stored to a non-transitory computer-readable storage medium of the onboard memory 250 and executed by the processor 245 to carry out the various functions attributed to the smart pen 110 that are described herein. The memory 250 may furthermore store the recorded audio, handwriting, and digital content, either indefinitely or until offloaded from the smart pen 110 to a computing system 115 or cloud server 125.

In an embodiment, the processor 245 and onboard memory 250 include one or more executable applications supporting and enabling a menu structure and navigation through a file system or application menu, allowing launch of an application or of a functionality of an application. For example, navigation between menu items comprises an interaction between the user and the smart pen 110 involving spoken and/or written commands and/or gestures by the user and audio and/or visual feedback from the smart pen computing system. In an embodiment, pen commands can be activated using a “launch line.” For example, on dot paper, the user draws a horizontal line from right to left and then back over the first segment, at which time the pen prompts the user for a command. The user then prints (e.g., using block characters) above the line the desired command or menu to be accessed (e.g., Wi-Fi Settings, Playback Recording, etc.). Using integrated character recognition (ICR), the pen can convert the written gestures into text for command or data input. In alternative embodiments, a different type of gesture can be recognized to enable the launch line. Hence, the smart pen 110 may receive input to navigate the menu structure from a variety of modalities.

### Synchronization of Written, Audio and Digital Data Streams

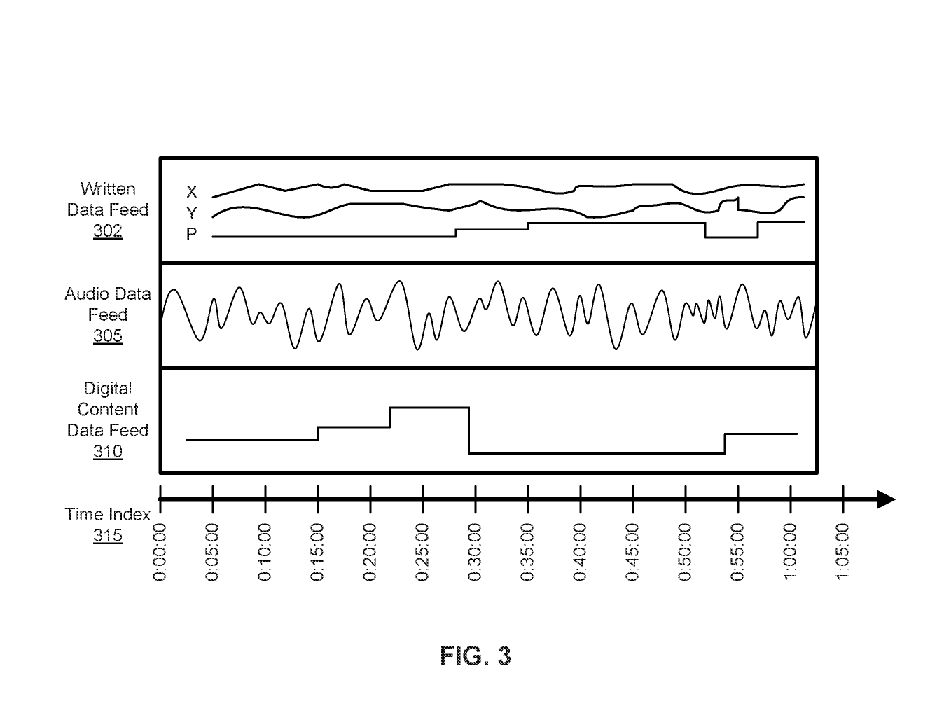

FIG. 3 illustrates an example of various data feeds that are present (and optionally captured) during operation of the smart pen 110 in the smart pen environment 100. For example, in one embodiment, a written data feed 300, an audio data feed 305, and a digital content data feed 315 are all synchronized to a common time index 315. The written data feed 302 represents, for example, a sequence of digital samples encoding coordinate information (e.g., “X” and “Y” coordinates) of the smart pen's position with respect to a particular writing surface 105. Additionally, in one embodiment, the coordinate information can include pen angle, pen rotation, pen velocity, pen acceleration, or other positional, angular, or motion characteristics of the smart pen 110. The writing surface 105 may change over time (e.g., when the user changes pages of a notebook or switches notebooks) and therefore identifying information for the writing surface is also captured (e.g., as page component “P”). The written data feed 302 may also include other information captured by the smart pen 110 that identifies whether or not the user is writing (e.g., pen up/pen down sensor information) or identifies other types of interactions with the smart pen 110.

The audio data feed 305 represents, for example, a sequence of digital audio samples captured at particular sample times. In some embodiments, the audio data feed 305 may include multiple audio signals (e.g., stereo audio data). The digital content data feed 310 represents, for example, a sequence of states associated with one or more applications executing on the computing device 115. For example, the digital content data feed 310 may comprise a sequence of digital samples that each represents the state of the computing device 115 at particular sample times. The state information could represent, for example, a particular portion of a digital document being displayed by the computing device 115 at a given time, a current playback frame of a video being played by the computing device 115, a set of inputs being stored by the computing device 115 at a given time, etc. The state of the computing device 115 may change over time based on user interactions with the computing device 115 and/or in response to commands or inputs from the written data feed 302 (e.g., gesture commands) or audio data feed 305 (e.g., voice commands). For example, the written data feed 302 may cause real-time updates to the state of the computing device 115 such as, for example, displaying the written data feed 302 in real-time as it is captured or changing a display of the computing device 115 based on an input represented by the captured gestures of the written data feed 302. While FIG. 3 provides one representative example, other embodiments may include fewer or additional data feeds (including data feeds of different types) than those illustrated.

As previously described, one or more of the data feeds 302, 305, 310 may be captured by the smart pen 110, the computing device 115, the cloud server 120 or a combination of devices in correlation with the time index 315. One or more of the data feeds 302, 305, 310 can then be replayed in synchronization. For example, the written data feed 302 may be replayed, for example, as a “movie” of the captured writing gestures on a display of the computing device 115 together with the audio data feed 305. Furthermore, the digital content data feed 310 may be replayed as a “movie” that transitions the computing device 115 between the sequence of previously recorded states according to the captured timing.

In another embodiment, the user can then interact with the recorded data in a variety of different ways. For example, in one embodiment, the user can interact with (e.g., tap) a particular location on the writing surface 105 corresponding to previously captured writing. The time location corresponding to when the writing at that particular location occurred can then be determined. Alternatively, a time location can be identified by using a slider navigation tool on the computing device 115 or by placing the computing device 115 is a state that is unique to a particular time location in the digital content data feed 210. The audio data feed 305, the digital content data feed 310, and or the written data feed may be re-played beginning at the identified time location. Additionally, the user may add to modify one or more of the data feeds 302, 305, 310 at an identified time location.

### Establishing and Maintaining an Authenticated Connection

As described above, data transfers may occur between the smart pen 110 and the computing device 110 (either directly or via the network 120) to enable a variety of different functions. In one embodiment, the smart pen 110 and the computing device 115 establish and maintain an authenticated connection to enable data transfers between the devices. For example, in one embodiment the devices 110, 115 discover each other, establish a provisional connection, confirm each other's identity, and establish a trusted relationship. Once established, the two devices 110, 115 can automatically re-discover and re-connect with each other in the future. Furthermore, different applications executing on the computing device 115 can be granted different privilege levels enforced by the authentication method, thus permitting varying levels of access to data from the smart pen 110 during an authenticated session.

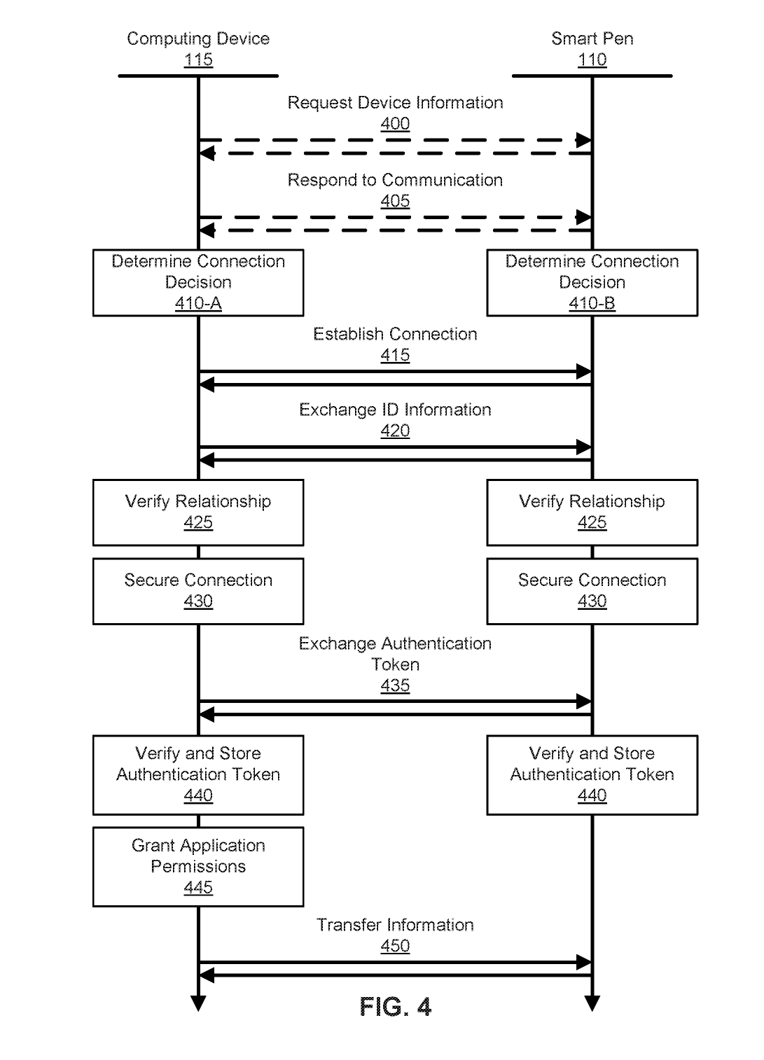

FIG. 4 illustrates an example embodiment of a process for establishing an authenticated connection between the computing device 115 and the smart pen 110. In a discovery stage, an originating device (which may be either the computing device 115, the smart pen 110, or both) initiates the communications by transmitting a request 400 for device information from other devices. For example, in one embodiment, the originating device (smart pen 110 or computing device 115) dispatches broadcasting request packets (e.g., UDP broadcast packets) to the local subnet via the network 120. If no response is received, then the originating device may continue to resend packets (and may stop resending packets when a stopping criterion is met). If a receiving device (which may be the computing device 115, the smart pen 110, or both) is connected to network 120 and receives the request 400 (e.g., UDP packet(s)), then the receiving device may respond by transmitting a response 405. For example, in one embodiment, the receiving device responds with a corresponding packet (e.g., UDP packet) of its own. This packet may be specifically addressed to the originating device and may carry information identifying the receiving device to the originating device. In FIG. 4, the request 400 and the response 405 are illustrated in dashed lines in both directions to represent that the request 400 and the response 405 can be transmitted in either direction or in both directions.

After the initial request 400 and response 405, both the originating device and the receiving device can then determine 410 whether to establish a connection with the other device, decline the connection, or stop connection attempts (e.g., if no responses are received). In one embodiment, the determination step 410 involves displaying a user prompt (e.g., on the smart pen 110 or the computing device 115) informing the user of the connection attempt, and determining whether to accept or decline the connection attempt based on the user's response.

For example, in one embodiment, the computing device 115 (e.g., a tablet) makes the initial request 400 for information about smart pens 110 that are connected to a local network 120. All of the smart pens 110 on the same network transmit a response 405 to the request 400 by sending packets carrying their serial number and other identifying information to the requesting computing device 115. For each of the responding smart pens 110, the computing device 115 then determines 410-A whether to discard the received information, to retain the received information, or to attempt to establish a connection with the smart pen 110. In an alternate embodiment, a smart pen 110 may make the initial request 400, receive responses 405 from one or more computing devices 115, and determine 410-B how to handle the received information.

The next stage of the establishment and maintenance of an authenticated connection is device pairing. By establishing a “pairing,” a smart pen 110 and a computing device 115 can automatically reconnect to each other without repeating a lengthy authentication process. In one embodiment, the pairing process is executed upon the user placing at least one of the smart pen 110 and the computing device 115 into a “pairing mode.” Once the smart pen 110 or computing device 115 is placed into a pairing mode it will not only respond to broadcast discovery requests (e.g., a request 400 for initial communication) but will also respond to pairing requests.

Once in pairing mode and assuming that each devices 110, 115 approves the connection to the other device in step 410, both devices establish 415 a connection to each other via network 120. For example, in one embodiment, the computing device 115 attempts to connect to a specific open socket on the smart pen 110 (or vice versa). Additional identification information is then exchanged 420 between the smart pen 110 and the computing device 115. The devices 110, 115 then verify 425 the relationship based on the additional identification information. For example, in one embodiment, the verification step 425 may include the smart pen 110 showing a pairing code on its display and the user entering the pairing code to the computing device 115 in order to finalize the connection. Alternatively, the pairing code may be displayed on the computing device 115 and entered on the smart pen 110. If the relationship is verified in step 425, the devices are paired.

To protect private and sensitive information recorded on devices 110, 115 against surreptitious connections by unauthorized devices or applications, both paired devices 110, 115 secure 430 the connection (e.g., using SSL/TLS) before further information can be exchanged. In one embodiment, certificates that are known to smart pen 110 and that are embedded in authorized applications executing on the computing device 115 are used to verify communications and secure 430 connections between the devices 110, 115. Thereafter, a validation/negotiation conversation between the devices 110, 115 begins.

In an alternative embodiment, initial pairing may be restricted to wired connections (e.g., via USB, micro-USB, or docking accessories). This protects the smart pen 110 and computing device 115 from unauthorized connections, particularly in sensitive work environments. Wired connections ensure that only pens that were authorized by a user could connect to computing devices 115, such as servers and computers. At the conclusion of the wired pairing, both smart pen 110 and computing device 115 may be authorized to establish wireless connections to each other.

Security can also be improved in an embodiment through the use of advanced/biometric user authentication methods. When a smart pen 110 and a computing device 115 establish a connection, the smart pen 110 may prompt the user for a verification of identity. For example, the smart pen 110 may request that the user write or type out on a printed keyboard a password. Alternatively, the user may be asked for a signature or to write out a word. The written gestures may be compared with recorded signatures or previous handwritten gestures to verify the user's identity. The smart pen 110 may also utilize voice authentication as a means of verifying identity.

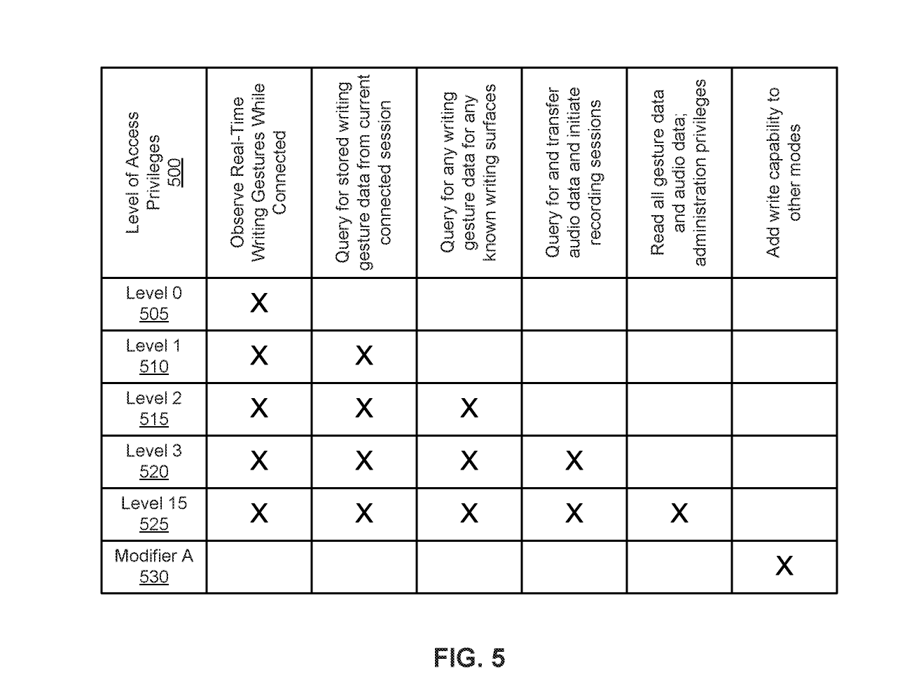

In one embodiment, security can be enhanced between connected devices by constraining the access privileges that different applications executing on the computing device 115 have to data stored by the smart pen 110 or by constraining access privileges that the smart pen 110 has to data stored by the computing device 115. In one embodiment, application developers who want to develop applications for use with the smart pen 110 are provided a connection toolkit/standard development kit (SDK) to communicate with the smart pen 110. The developer is also given an application programming interface (API) token to include with the application. During the validation/negotiation conversations, this API token is exchanged 435 between devices 110, 115 (e.g., either a one way or a two way exchange). Each token is encoded with specific access level privileges authorized to the application. When the application executes on the computing device 115, the smart pen 110 verifies 440 the token and checks it against an internal blacklist before granting 445 access to the application. The user may also be prompted to verify the level of access authorized to the application before the application is granted 445 access data on the smart pen 110. Access privileges may include, for example, allowing an application write/delete access to data stored in the smart pen 110 as well as simple read/observation access to data stored in the smart pen 110. Additional examples of varying levels of access privileges are described below with respect to FIG. 5.

The authentication tokens may be stored locally to allow the devices 110, 115 to automatically reconnect to each other in the future and to enable previously verified applications to communicate with the smart pen 110 according to their granted privilege levels. After exchanging and storing the tokens, the two devices are able to communicate with each other and transfer 450 information to the extent allowed for by the application specific permissions. When the connection between the two devices is closed, the devices are free to reconnect to each other at a later time.

A prior pairing between devices enables a specific computing device 115 and smart pen 110 to seek each other out for automatic reconnection at later times. For example, a connection may be automatically re-established in response to specific events such as when a specific time interval elapses, when prompted by the user, or in response to activation or network change events. In one embodiment, a user may initiate a seeking operation by launching or tapping a control in an application on the computing device 115. In another embodiment, a user could initiate a seeking operation by using a smart pen 110 to tap an icon on a compatible writing surface 105 with their pen or by using a launch line or ICR. In the case of a failure, the user may be prompted (if the connection was explicitly requested by the user) or may be ignored (if the connection had been implicitly triggered). When a re-connection is successful, the devices will be paired according to the access granted during the prior pairing or according to the privileges specified in the authentication tokens stored locally.

In one embodiment, a temporary connection between a computing device 115 and a smart pen 110 may alternatively be established for scenarios in which a long-term authenticated connection is not necessarily desirable. For example, a smart pen 110 may connect to a computing device 115 for the purposes of a one-time or limited access data exchange. In this scenario, the devices are discovered as described above and a connection is established (which may or may not be explicitly approved by a user in different embodiments). However, rather than pairing the devices in the manner described above, the authentication tokens exchanged 435 between the devices 110, 115 are not stored on the devices 110, 115. The two devices 110, 115 are thus unable to automatically reconnect at a later time.

In an embodiment, the smart pen 110 and computing device 115 are capable of establishing and maintaining a connection even when an infrastructure network is not available (e.g., a home or office Wi-Fi access point, public Wi-Fi hotspot, or mobile hotspot). In this embodiment, the smart pen 110 establishes and broadcasts its own temporary network (e.g., AdHoc network). The smart pen 110 broadcasts the availability of an AdHoc network and begins listening for traffic on the established network. Other devices (e.g., a computing device 115) can then connect to the smart pen 110 on the AdHoc network using previously described methods for establishing and maintaining an authenticated connection. In one embodiment, the smart pen 110 automatically establishes the AdHoc network in response to detecting that no infrastructure wireless network is accessible.

### Access Level Privileges

As described, above, different applications are allowed different levels of access to information on a smart pen 110 depending on the privilege level encoded in their respective authentication tokens. Different privilege levels provide different privileges with respect to reading, writing, and modifying data stored to a smart pen 110 and to observing real-time data from the smart pen 110. In one embodiment, modifiers within each privilege level further fine-tune the particular privileges of a given application.

FIG. 5 illustrates an example embodiment of a table 500 of possible privilege levels that can be encoded into the authentication tokens. In the table of FIG. 5, each increasing privilege level allows applications the same privileges permitted by lower levels as well as one or more additional privileges.

For example, level 0 (505) is the lowest privilege level. Applications assigned to level 0 (505) are only allowed to observe real-time writing gestures when the smart pen 110 is connected but have no access to historical data. For example, applications assigned to level 0 (505) may receive data from the pen up/pen down sensor, gesture data, position information, and other basic information about the smart pen 110.

Applications assigned to level 1 (510) are afforded the same privileges from level 0 (505), and are additionally permitted applications to query for writing gesture data stored by the pen 110 during a current connected session with the smart pen 110 (including during periods when the smart pen 110 should have been “connected,” in the case of an accidental disconnection and subsequent reconnection). However, applications assigned to level 1 do not have access to data from previous sessions before the current connection was established.

Application assigned to level 2 (515) are allowed to query for any writing gesture data stored by the smart pen 110 that are associated with writing surfaces 105 known to the application (e.g., particular pages of a notebook). For example, an application assigned to level 2 (515) can access writing gesture data from any writing surface 105 written on while the application and the smart pen 110 were connected, even if some of the writing gesture data was not captured during the current session.

Applications assigned to level 3 (520) are further allowed to query for and transfer audio data together with writing gesture data and initiate recording sessions. Thus, the application has permission to access and download any audio recordings and pen strokes associated with the audio recordings.

Applications assigned to level 15 (525) is an administrative privilege level affording the highest privilege level. Applications assigned to level 15 are able to read gesture data and audio data, access account information associated with a user of the smart pen 110, and read or modify other configuration information of the smart pen 110.

Modifiers may be applied to an access level to provide additional flexibility in the privilege structure. When enabled for a given application, a modifier grants one or more additional privileges on top of those already permitted by the specified privilege level encoded on the authentication tokens. For example, modifier A (530) gives applications a write capability 560, which includes the ability to add metadata to the writing gesture data and audio data in the smart pen 110. Other modifiers may also be available for encoding into the authentication tokens in various embodiments. For example, in one embodiment, an additional modifier enables or disables access to stored digital data (e.g., from digital content data feed 310).

### Additional Embodiments

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it7has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
transmitting a request from a smart pen for device information for a computing device;
receiving, by the smart pen, a response from the computing device regarding the transmitted request;
determining whether a wireless connection should be established between the smart pen and the computing device based on the response;
responsive to determining that the wireless connection should be established, establishing the wireless connection;
receiving from the computing device, a token encoding a privilege level for an application executing on the computing device, the privilege level selected from a set of predefined privilege levels including at least a first privilege level that enables access only to real-time gesture data but denies access to previously captured historical data stored on the smart pen, and a second privilege level that enables access to both the real-time gesture data and the previously captured historical data;
receiving a request from the application executing on the computing device for the previously captured historical data stored on the smart pen; and
determining, by the smart pen, whether to allow or deny the request from the application from the smart pen based on the privilege level for the application encoded in the token.

2. The computer-implemented method of claim 1, further comprising:
detecting a loss of the wireless connection; and
automatically re-establishing the wireless connection.

3. The computer-implemented method of claim 1, wherein the historical data stored on the smart pen comprises at least one of the following: gesture data, position data, basic device data, audio data, and account data.

4. The computer-implemented method of claim 1, wherein determining whether to allow or deny the request from the application comprises:
determining, based on the privilege level, whether to allow or deny a request from the application to access the real time gesture data from the smart pen as the data is generated.

5. The computer-implemented method of claim 1, wherein determining whether to allow or deny the request from the application comprises:
determining, based on the privilege level, whether to allow or deny a request from the application to access gesture data and audio data stored by the smart pen.

6. The computer-implemented method of claim 1, wherein determining whether to allow or deny the request from the application comprises:
determining, based on the privilege level, whether to allow or deny a request from the application to access account information associated with a user of the smart pen.

7. The computer-implemented method of claim 1, wherein determining whether to allow or deny the request from the application comprises:
determining, based on the privilege level, whether to allow or deny a request from the application to modify data stored by the smart pen.

8. The computer-implemented method of claim 1, wherein the token further includes a modifier that alters an access privilege level from the set of predefined privilege level.

9. The computer-implemented method of claim 8, wherein determining whether to allow or deny the request from the application comprises:
determining, based on the modifier whether to allow or deny a request from the application to add metadata to data stored by the smart pen.

10. A smart pen device comprising:
a processor integrated within the smart pen device;
a gesture capture system integrated within the smart pen device, the gesture capture system coupled to the processor and the gesture capture system for capturing written data; and
a non-transitory computer-readable storage medium storing computer program code and integrated within the smart pen device, the computer program code configured to be executed by the processor, the computer program code including instructions for:
transmitting a request from a smart pen for device information for a computing device;
receiving, by the smart pen, a response from the computing device regarding the transmitted request;
determining whether a wireless connection should be established between the smart pen and the computing device based on the response;
responsive to determining that the wireless connection should be established, establishing the wireless connection; and
receiving from the computing device, a token encoding a privilege level for an application executing on the computing device, the privilege level selected from a set of predefined privilege levels including at least a first privilege level that enables access only to real-time gesture data but denies access to previously captured historical data stored on the smart pen, and a second privilege level that enables access to both the real-time gesture data and the previously captured historical data;
receiving a request from the application executing on the computing device for data stored on the smart pen; and
determining, by the smart pen, whether to allow or deny the request from the application from the smart pen based on the privilege level for the application encoded in the token.

11. The smart pen device of claim 10, further comprising:
detecting a loss of the wireless connection; and
automatically re-establishing the wireless connection.

12. The smart pen device of claim 10, wherein the historical data stored on the smart pen comprises at least one of the following: gesture data, position data, basic device data, audio data, and account data.

13. The smart pen device of claim 10, wherein determining whether to allow or deny the request from the application comprises:
determining, based on the privilege level, whether to allow or deny a request from the application to access the real time gesture data from the smart pen as the data is generated.

14. The smart pen device of claim 10, wherein determining whether to allow or deny the request from the application comprises:
determining, based on the privilege level, whether to allow or deny a request from the application to access gesture data and audio data stored by the smart pen.

15. The smart pen device of claim 10, wherein determining whether to allow or deny the request from the application comprises:
determining, based on the privilege level, whether to allow or deny a request from the application to access account information associated with a user of the smart pen.

16. The smart pen device of claim 10, wherein determining whether to allow or deny the request from the application comprises:
determining, based on the privilege level, whether to allow or deny a request from the application to modify data stored by the smart pen.

17. The smart pen device of claim 10, wherein the token further includes a modifier that alters an access privilege level from the set of predefined privilege level.

18. The smart pen device of claim 17, wherein determining whether to allow or deny the request from the application comprises:
determining, based on the modifier whether to allow or deny a request from the application to add metadata to data stored by the smart pen.

19. A non-transitory computer-readable storage medium storing computer program code configured to be executed by the processor, the computer program code including instructions for:
transmitting a request from a smart pen for device information for a computing device;
receiving, by the smart pen, a response from the computing device regarding the transmitted request;
determining whether a wireless connection should be established between the smart pen and the computing device based on the response;
responsive to determining that the wireless connection should be established, establishing the wireless connection; and
receiving from the computing device, a token encoding a privilege level for an application executing on the computing device, the privilege level selected from a set of predefined privilege levels including at least a first privilege level that enables access only to real-time gesture data but denies access to previously captured historical data stored on the smart pen, and a second privilege level that enables access to both the real-time gesture data and the previously captured historical data;
receiving a request from the application executing on the computing device for data stored on the smart pen; and
determining, by the smart pen, whether to allow or deny the request from the application from the smart pen based on the privilege level for the application encoded in the token.
